(19) United States
(12) Patent Application Publication
(10) Pub. No.: US 2014/0226607 A1
(43) Pub. Date: Aug. 14, 2014

(54) Apparatus and Method for Communication

(71) Applicant: Nokia Solutions and Networks Oy, Espoo (FI)

(72) Inventors: Harri Kalevi Holma, Helsinki (FI); Bernhard Raaf, Neuried (DE); Esa Tapani Tiirola, Kempele (FI)

(21) Appl. No.: 14/346,017

(22) PCT Filed: Sep. 21, 2011
(86) PCT No.: PCT/EP2011/066469

§ 371 Date: Mar. 20, 2014

(51) Int. Cl. H04L 1/00; H04L 27/26

(52) U.S. Cl. CPC H04L 1/0083; H04L 27/2602; H04L 1/0079; H04L 1/0084
USPC 370/329

(57) ABSTRACT

Apparatus and method for communication are provided. In the proposed solution communication on a shared channel utilizes a first format based on sub frame length and/or a second format based on Orthogonal Frequency-Division Multiple Access symbol length.

### FIELD

The exemplary and non-limiting embodiments of the invention relate generally to wireless communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless communication systems are constantly under development. Developing systems provide a cost-effective support of high data rates and efficient resource utilization. One communication system under development is the 3rd Generation Partnership Project (3GPP) Long Term Evolution (LTE). An improved version of the Long Term Evolution radio access system is called LTE-Advanced (LTE-A). The LTE and LTE-A are designed to support various services, such as high-speed data. Another developed system is so called Beyond 4G (B4G) radio system which is assumed to be operational in the future.

In future, mobile broadband traffic is expected to increase significantly. A need for systems supporting very high data rates is clear. The design of high data rate communication faces many problems. One of the problems is latency which is due to processing delays in transceivers, for example. In LTE it is a well know problem that user plane latency is “hard-coded” in the system. The main building blocks behind the latency components are transmission time interval (TTI), control signalling, hybrid automatic repeat request (HARQ) and reference signal design. The minimum two-way latency for the present LTE system equals to 10 ms. Thus, there is a need for a solution for obtaining major latency improvements taking the legacy LTE user equipment operating on the same carriers into account.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, comprising: at least one processor and at least one memory including a computer program code, the at least one memory and the computer program code configured to, with the at least one processor, cause the apparatus at least to: control communication on a shared channel, the communication utilizing a first format based on sub frame length and/or a second format based on Orthogonal Frequency-Division Multiple Access symbol length.

According to another aspect of the present invention, there is provided a method comprising: controlling communication on a shared channel, the communication utilizing a first format based on sub frame length and/or a second format based on Orthogonal Frequency-Division Multiple Access symbol length.

According to an aspect of the present invention, there is provided an apparatus, comprising: at least one processor and at least one memory including a computer program code, the at least one memory and the computer program code configured to, with the at least one processor, cause the apparatus at least to: control communication on a shared channel, the communication utilizing a format based on Orthogonal Frequency-Division Multiple Access symbol length.

According to yet another aspect of the present invention, there is provided an apparatus comprising means for controlling communication on a shared channel, the communication utilizing a first format based on sub frame length and/or a second format based on Orthogonal Frequency-Division Multiple Access symbol length.

### LIST OF DRAWINGS

Embodiments of the present invention are described below, by way of example only, with reference to the accompanying drawings, in which

FIG. 1 illustrates an example of a radio system;

FIG. 2 illustrates an example of latency in LTE based system;

FIG. 3 illustrates the sub frame structure used in LTE uplink;

FIG. 4 is a flowchart illustrating an embodiment;

FIG. 5 illustrates an example of downlink arrangement supporting multiplexing of legacy UEs and low latency UEs in the same sub frame;

FIG. 6 illustrates an example of uplink arrangement;

FIG. 7 illustrates an example of an uplink HARQ process design;

FIG. 8 shows an example of a downlink HARQ process design for low latency SPDSCH;

FIG. 9 illustrates another example of a HARQ process design; and

FIGS. 10A and 10B illustrate examples of apparatuses of an embodiment.

### DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present invention are applicable to any network element, node, base station, relay node, server, corresponding component, and/or to any communication system or any combination of different communication systems that support required functionalities. The communication system may be a wireless communication system or a communication system utilizing both fixed networks and wireless networks. The protocols used and the specifications of communication systems, servers and user terminals, especially in wireless communication, develop rapidly. Such development may require extra changes to an embodiment. Therefore, all words and expressions should be interpreted broadly and are intended to illustrate, not to restrict, the embodiment.

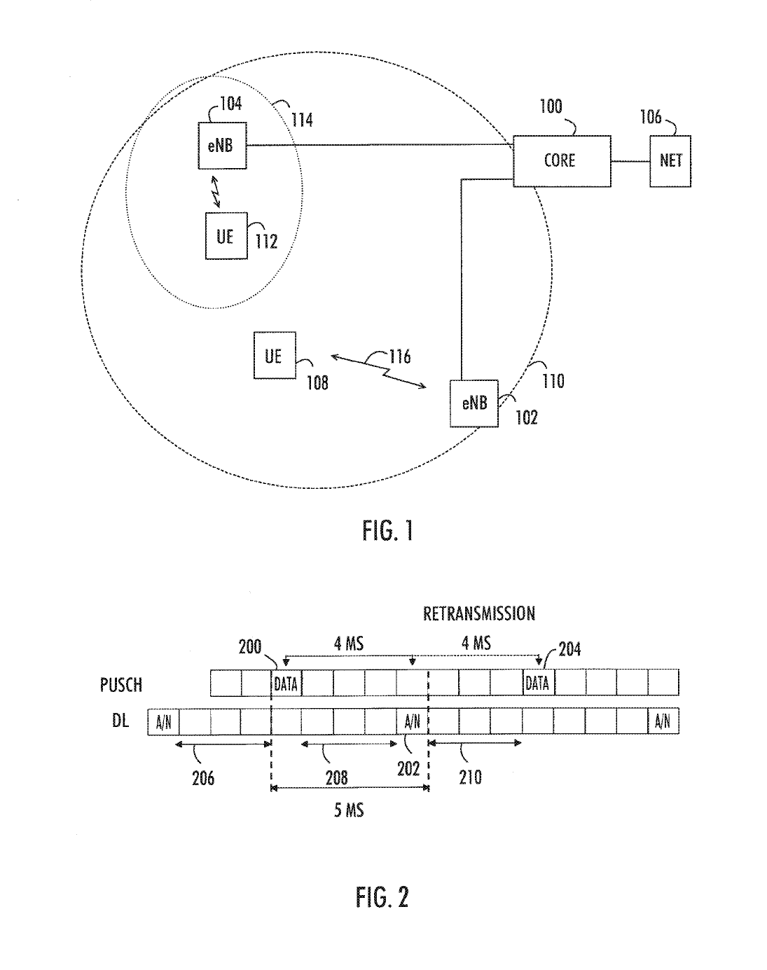

With reference to FIG. 1, let us examine an example of a radio system to which embodiments of the invention can be applied.

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

The exemplary radio system of FIG. 1 comprises a service core 100 of an operator.

In an embodiment, base stations that may also be called eNodeBs (Enhanced node Bs) 102, 104 of the radio system may host the functions for Radio Resource Management: Radio Bearer Control, Radio Admission Control, Connection Mobility Control, Dynamic Resource Allocation (scheduling). The core network 100 is configured to act as a gateway between the network and other parts of communication network such as the Internet 106, for example.

FIG. 1 illustrates user equipment UE 108 located in the service area 110 of the eNodeB 100 and UE 112 located in the service area 114 of the eNodeB 104. User equipment refers to a portable computing device. Such computing devices include wireless mobile communication devices, including, but not limited to, the following types of devices: mobile phone, smartphone, personal digital assistant (FDA), handset, laptop computer. The apparatus may be battery powered. The network may comprise base stations with service areas of different sizes and properties. In the example of FIG. 1, the base station 102 servers a large coverage area and the base station 104 is serving a micro or pico cell. Embodiments of the invention are not limited to any particular cell size or cell type.

In the example situation of FIG. 1, the user equipment 108 has a connection 116 with the eNodeB 102. The connection 116 may be a bidirectional connection related to a speech call or a data service such as browsing the Internet 106.

FIG. 1 only illustrates a simplified example. In practice, the network may include more base stations and more cells may be formed by the base stations. The networks of two or more operators may overlap, the sizes and form of the cells may vary from what is depicted in FIG. 1, etc.

The embodiments are not restricted to the network given above as an example, but a person skilled in the art may apply the solution to other communication networks provided with the necessary properties. For example, the connections between different network elements may be realized with Internet Protocol (IP) connections.

FIG. 2 illustrates an example of latency on the user plane of an LTE based system. The example relates to uplink data transmission on PUSCH (Physical Uplink Shared Channel). In this example, UE transmits data 200 on PUSCH, the base station sends a downlink response 202 requesting retransmission and the UE transmits retransmission packet 204. The length of a subframe 200, 202, 204 is 1 ms. Following latency components (ignoring propagation delay and uplink/downlink frame misalignment) can be seen:

UE processing time 206 prior to PUSCH transmission is 3 ms. PUSCH transmission and eNB processing delay 208 prior sending HARQ A/N 202 is 4 ms. The HARQ A/N transmission on PDCCH (Physical Downlink Control Channel) and UE message processing delay 210 is 1 to 4 ms. Thus, total latency of a successful transmission is 5 to 8 ms (ignoring scheduling delay). Each HARQ retransmission increases latency by 8 ms.

The communication in the LTE based system is thus sub frame based.

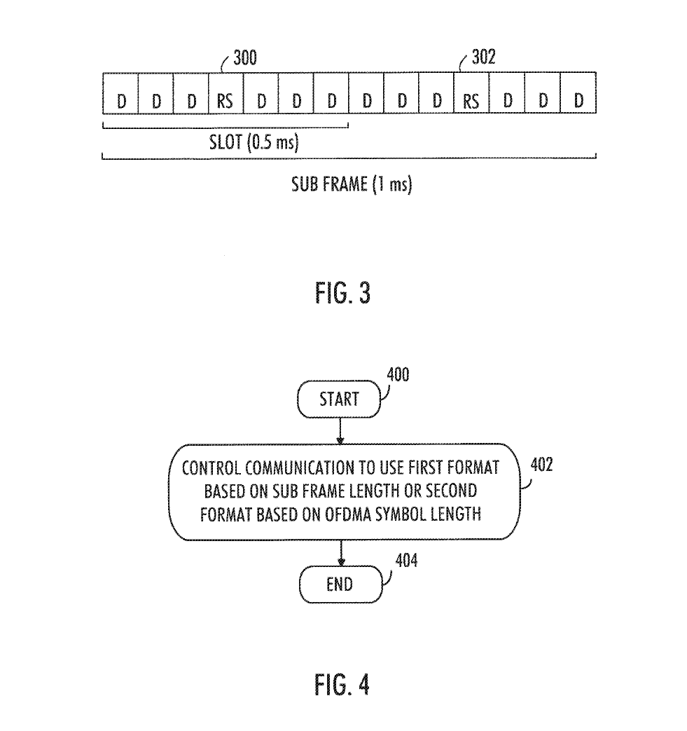

FIG. 3 shows the sub frame structure used in LTE uplink and normal cyclic prefix length. Each sub-frame (TTI) comprises 14 OFDMA symbols where two reference symbol blocks 300, 302 which are placed symmetrically within the subframe. In known LTE system, the minimum transmission time interval equals to one sub frame, i.e. 14 OFDMA symbols. The length of the sub frame is 1 ms, the length of a slot is 0.5 ms and the length of each OFDMA symbol (including cyclic prefix) is 71 μs.

In an embodiment, a low-latency transmission format or configuration is created on top of the existing LTE frame structure. The resources for transmission using the format are orthogonal to the resources reserved for connection utilising the known transmission format. Thus, legacy transceivers using the known format are not interference by or even aware of the proposed low-latency transmission format.

In an embodiment, user equipment or eNodeB communicating on a shared channel is configured to utilize either a first format based on sub frame length or a second format based on Orthogonal Frequency-Division Multiple Access symbol length, or both. The first format is the above described known format and the second format is a low-latency format.

In an embodiment, the second format utilizes a transmission time interval having a length which is L times the length of an Orthogonal Frequency-Division Multiple Access symbol where L is a positive integer. This means that the TTI length equals to L times 71 μs on top of LTE/LTE-A and normal cyclic prefix length.

Further, user equipment processing time may be defined as M times the duration of one OFDMA symbol, where M is a positive integer. In an embodiment, the UE processing time may be different for different cases. For example, the UE processing time from receiving a grant to transmit on a shared channel to the transmission is M1 times the length of an Orthogonal Frequency-Division Multiple Access symbol where M1 is a positive integer. Likewise, the UE processing time from receiving a control message on a control channel to an acknowledgement transmission on a shared channel is M2 times the length of an Orthogonal Frequency-Division Multiple Access symbol where M2 is a positive integer. Here M1 may be equal or different to M2.

In an embodiment, the eNodeB processing time from receiving a communication on shared channel to an acknowledgement transmission is N times the length of an Orthogonal Frequency-Division Multiple Access symbol where N is a positive integer.

The transmission time intervals may be different on different channels.

FIG. 4 is a flowchart illustrating an embodiment. The process starts at step 400. In step 402, communication of user equipment or an eNodeB on a shared channel is controlled to utilize a first format based on sub frame length and/or a second format based on Orthogonal Frequency-Division Multiple Access symbol length. The process ends at step 404.

Next, the low-latency format or configuration is described in more detail. The configuration or format itself can be communicated using dedicated Radio Resource Control (RRC) signalling. Part of the signalling may be made also using broadcasted system information. The format may be implemented both at user equipment and eNodeB.

In an embodiment, the low-latency format communication is applied on one or more control channels transmitted between user equipment and eNodeB. Examples of channels utilized in LTE based communication systems are

| | |
|---|---|
| PDFICH | Physical Control Format Indicator Channel |
| PDCCH | Physical Downlink Control Channel |
| PDSCH | Physical Downlink Shared Channel |
| PUCCH | Physical Uplink Control Channel |
| PUSCH | Physical Uplink Shared Channel |

Thus, these channels are used in communication utilising the first format. Also so-called legacy UEs not supporting the second format communication utilise only these channels.

In communication utilising the second low-latency format, following channels may be defined, for example:

| | |
|---|---|
| S-PCFICH | Short Physical Control Format Indicator Channel |
| S-PDCCH | Short Physical Downlink Control Channel |
| S-PDSCH | Short Physical Downlink Shared Channel |
| S-PUCCH | Short Physical Uplink Control Channel |
| S-PUSCH | Short Physical Uplink Shared Channel |

Here, the channels are denoted with letter ‘S’ to distinguish them from the legacy counterparts. The operation and use of each channel is the same as the use of the legacy counterpart.

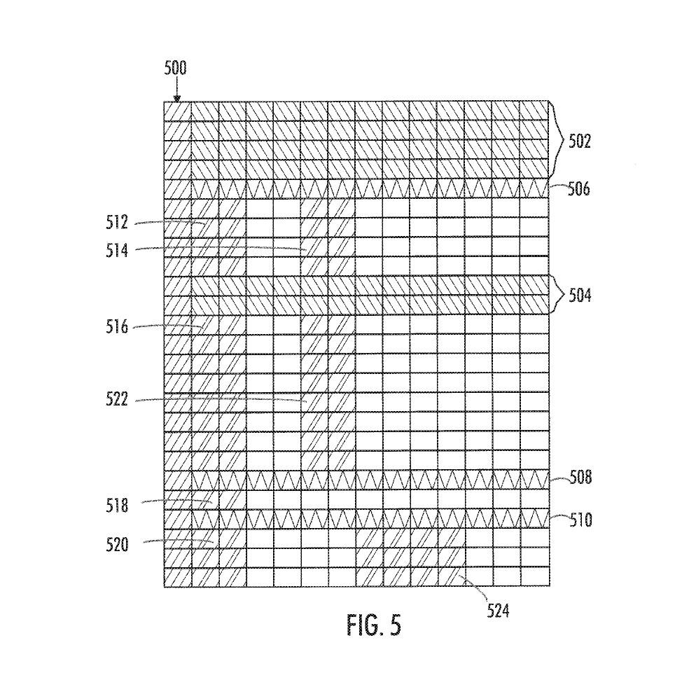

FIG. 5 illustrates an example of downlink arrangement supporting multiplexing of legacy UEs and “low latency UEs” in the same sub frame. The figure shows partial frequency/time resource block where time runs on the x-axis and frequency on the y-axis. One block equals to the smallest scheduling unit. FIG. 5 shows a sub frame comprising 14 OFDMA symbols.

PCFICH, PDCCH and PHICH for first format (legacy) communication are transmitted in the first time slots 500. Physical Downlink Shared Channel PDSCH for first format (legacy) communication comprises given resources 502, 504. S-PHICH and S-PDCCH are transmitted in slots 506. 508 and 510. Short Physical Downlink Shared Channel S-PDSCH is transmitted in slots 512 to 524. The allocations depicted in FIG. 5 are merely illustrative examples of allocation strategies.

S-PDCCH/S-PHICH targeted to low latency UEs can be transmitted on dedicated resources. These semi-statically configured resources can be set-up via higher layer signalling. In order to minimize the scheduling restrictions for the legacy UEs, the existing resource allocation methods may be applied to allocate S-PDCCH/S-PHICH resources targeted to low latency UEs.

In an embodiment, UE has capability to receive both PDCCH and S-PDCCH and S-PDSCH during the same OFDMA symbol.

In an embodiment, S-PDCCH is transmitted only on the current PDSCH resources. In other words, OFDMA symbols carrying PCFICH. PHICH and PDCCH for legacy UEs are not available for shortened S-PDSCH. This has been assumed also in the example of FIG. 5. Alternatively, some Control Channel Element CCE may be assigned for low latency UEs. They may use those for either/both data and control. Thus, apart from stealing PDSCH resources (which would be several Physical Resource Blocks PRBs) for the low latency channels, also CCEs may be stolen. The CCEs are interleaved over a few PRBs in the first symbols of a LTE sub frame, but a single CCE typically does not occupy the entire resources of a PRB. The existing reference signals (Common Reference Signal CSR, Demodulation Reference Signals DM-RS and Channel State Information Reference Signal CSI-RS) can be used to decode PDCCH/PHICH and shortened S-PDSCH at the UE. Re-arrangements for the DM-RS may be made in order to get dedicated reference signal available in each Transmission Time Interval.

In an embodiment, the resources that are assigned to S-PDCCH are a subset of the PRBs which are not used for legacy UEs. The S-PDCCH may be transmitted in this subset. It is advantageous if the UEs know on which PRBs to search for the S-PDCCH. This can be achieved by assigning a set of PRBs semi-statically to be used potentially for S-PDCCH. The set may still be used for legacy PDSCH, if no S-PDCCH is used in a particular sub frame at all. Alternatively, the allocated PRBs can be indicated with the help of the legacy Relay Physical Downlink Control Channel R-PDCCH in a similar way as resources for UEs are indicated. In this case, the UEs don't only have to scan for legacy PDCCH but also for a special message indicating the resources for S-PDCCH. This however allows fast dimensioning of the resources used for S-PDCCH. In an embodiment. S-PDCCH may occupy more PRBs because the information has to be squeezed into only a few OFDM symbols and therefore has to occupy more space in frequency domain.

In current LTE systems, PDCCH is transmitted first and the PDSCH for one UE. In the present proposition S-PDCCH and S-PDSCH may be transmitted in parallel.

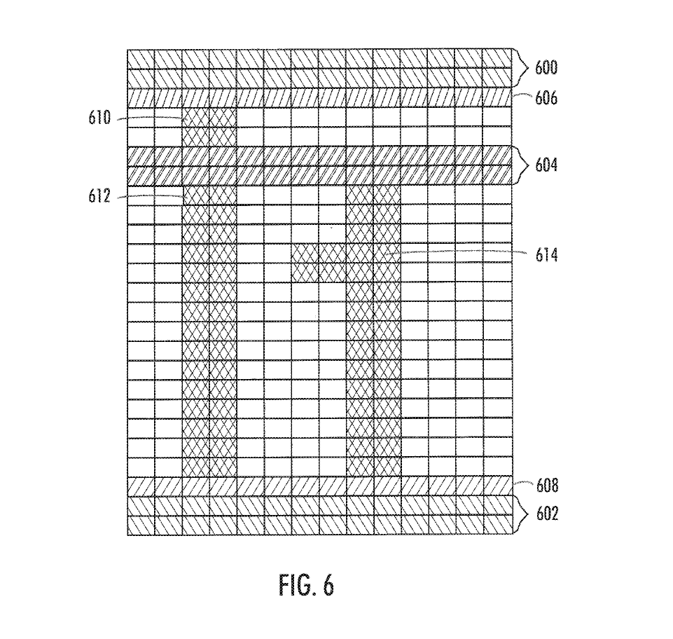

FIG. 6 illustrates an example of uplink arrangement supporting multiplexing of legacy UEs and “low latency UEs” in the same sub frame. As with FIG. 5, the figure shows partial frequency/time resource block where time runs on the x-axis and frequency on the y-axis. One block equals to the smallest scheduling unit.

PUCCH for first format (legacy) users is transmitted in slots 600, 602. PUSCH for first format (legacy) users is transmitted in slots 604. SPUCCH for low-latency UEs is transmitted in slots 606, 608 and SPUSCH for low-latency UEs is transmitted in slots 610 to 614. The allocations depicted in FIG. 6 are merely illustrative examples of allocation strategies.

In an embodiment, existing PUSCH resources can be used for shortened S-PUSCH as well.

It may be noted that SC-FDMA is not the most flexible transmission scheme in terms of adjusting the reference signal overhead (granularity with limited number of blocks is coarse). It is possible to consider OFDMA for S-PUSCH if low cubic metric properties of the transmitted signal are lost in any case due to RS granularity issue. In the OFDMA approach it is possible to multiplex the Reference Signal RS and data within the symbol and interleave the RS in frequency similarly as in the downlink side (DM-RS).

Legacy allocations of UEs need to be maintained for the entire duration of a sub frame. Therefore in an embodiment, two non-consecutive blocks 600, 602 of PRBs may need to be available as shown in the figure. Then two (or more) sets 610, 612, 614 of PRBs may be scheduled to the S-PUSCH, similarly as applying carrier aggregation, at the expense of higher cubic metric.

Existing PUCCH Format 2 resources can be used for low latency Ack/Nack and low latency Scheduling Request SR with very small modifications to the legacy format. An example of a simple modification is to apply two symbols for S-PUCCH, one for control and another for RS. It is noted that shortened format could coexist with legacy even in code domain. However, shortened format may require its own PRR resources due to power difference between legacy and low-latency format (that would be around 10 dB with 2-symbol PUCCH allocation). This has been assumed in FIG. 6.

In an embodiment, the eNodeB has the capability to switch dynamically between the first and second format, or legacy configuration and low latency configuration. This can be achieved in a way that UE may be configured to decode both legacy PDCCH and low-latency S-PDCCH during the same sub frame at the expense of some more blind decodings.

Shortened transmission tile interval of the low latency format may lead to power loss which may need to be compensated. In an embodiment, it sis compensated autonomously using a scaling factor BW_{scaling}_{—factor} included in the power control algorithms. An example of such scaling factor could be:

$${BW}_{scaling\_factor} = 10 {log}_{10} ( \frac{{N}_{subframe}^{sym} ( i )}{L} ) ,$$

where N_{subframe}^{sym} equals to number of symbols per sub frame (i.e., 14 with the normal cyclic prefix length) and L equals to number of OFDMA symbols per transmission tile interval.

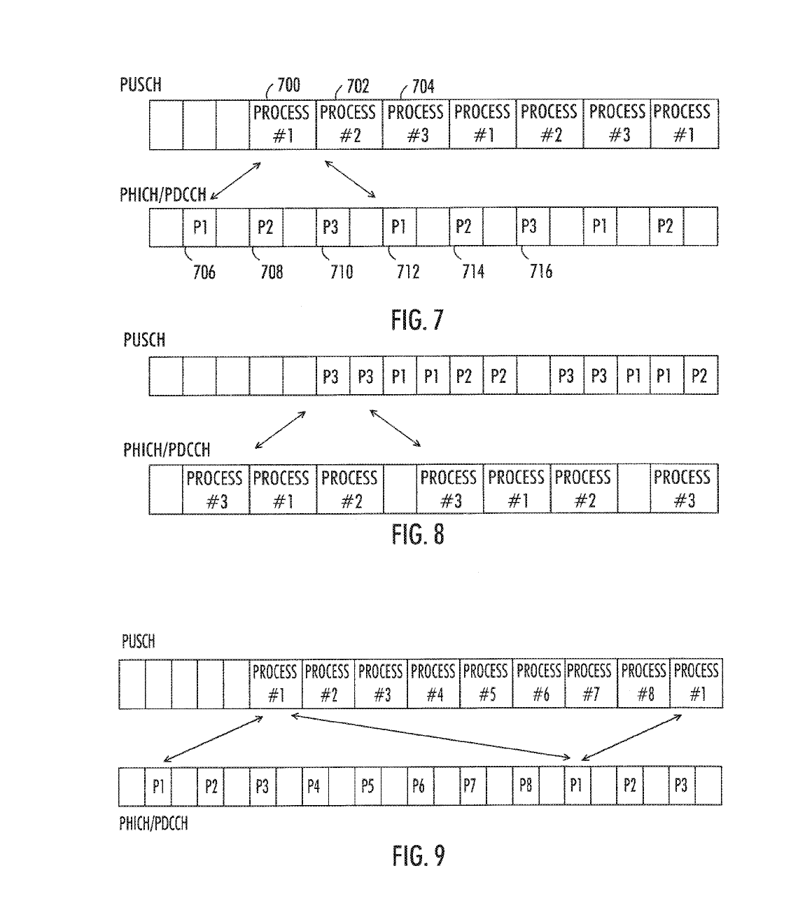

Let us next study HARQ subsystem. FIG. 7 illustrates an example of an HARQ process design for the low legacy S-PUSCH assuming three HARQ processes 700. 702, 704 and TTI length of two OFDMA symbols respectively.

First process 700 receives a transmission grant in downlink slot 706, performs transmission in slot 700, and HARQ A/N is sent in downlink slot 708.

Correspondingly, the second process 702 receives a transmission grant in downlink slot 710, performs transmission in slot 702, and HARQ ACK/NACK is sent in downlink slot 712. Likewise the third process 706 receives a transmission grant in downlink slot 714, performs transmission in slot 704, and HARQ ACK/NACK is sent in downlink slot 716. Thus, here the UE processing time has the length of one OFDMA symbols and the eNodeB processing time has the length of two OFDMA symbols.

The design shown in FIG. 7 enables to keep the first OFDMA of the sub frame symbol free from HARQ ACK/NACK (SPHICH) and uplink grants (SPDCCH). This is advantageous as the first symbol is typically heavily used for PDCCH. PHICH and PCFICH for legacy UEs. Keeping one symbol free in the uplink can also be beneficial, if this symbol is used for SRS (Sounding reference symbols) for legacy UEs, because those may occupy the entire system bandwidth so that it is not possibly to squeeze in some new channels in this symbol (not shown in the figure).

The three HARQ processes require a reaction time of one symbol at the UE from S-PHICH/S-PDCCH to sending the packet and of two symbols at the eNodeB from receiving the packet until sending ACK/NACK on S-PHICH, including propagation delay. If this is too short, more HARQ processes can be used at the expense of increased Round Trip Time RTT (increasing roughly by two symbols per additional HARQ process).

FIG. 8 shows an example of an HARQ process design for the low latency SPDSCH assuming three HARQ processes and TTI length of 2 OFDMA symbols respectively. The design shown in FIG. 8 enables to keep the first OFDMA symbol of the sub frame free from downlink grant (SPDCCH) and low latency SPDSCH (as the first symbol is already occupied by PDCCH for the legacy UEs). It should be noted that the figure only shows the SPUCCH blocks corresponding to the first six SPDCCH blocks (two for each process). The seventh OFDM symbol is kept blank as well, as 14−1=13 blocks cannot be nicely divided into shorter SPDCCH blocks, but 12 can be nicely divided.

Another exemplary HARQ process design is shown in FIG. 9. It maximizes the commonality with LTE having eight HARQ processes in use.

Note when comparing the example figures on uplink and downlink HARQ operation it becomes apparent that the ACK/NACK signalling in the downlink direction are shorter than in the uplink direction. In an embodiment, this is done to allow a larger range in uplink where the UE cannot concentrate the power efficiently in a short time. The disadvantage is that then the uplink timing is more constrained and e.g. requires some idle symbols (the first and eights symbol in FIG. 8) to make sure there is time e.g. from receiving the SPUCCH after the seventh symbol to sending the SPDCCH/SPDSCH in the ninth symbol.

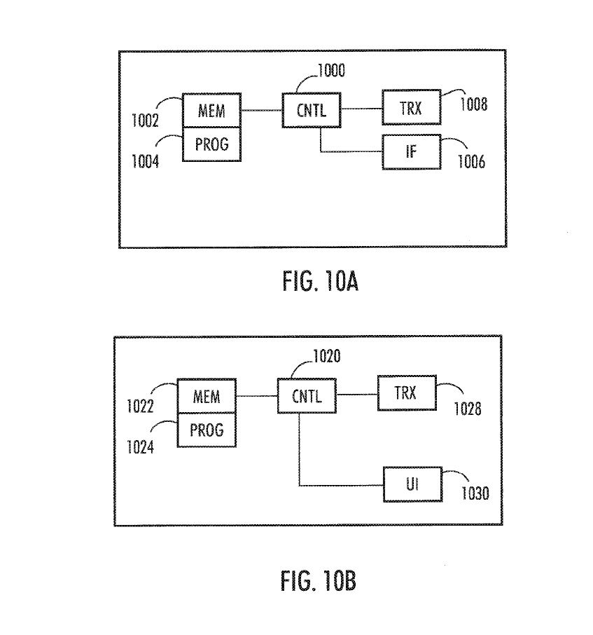

FIG. 10A illustrates an embodiment. The figure illustrates a simplified example of an apparatus applying embodiments of the invention. In some embodiments, the apparatus may be an eNodeB of a communications system. In an embodiment, it is a separate network element.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 1000 configured to control at least part of the operation of the apparatus.

The apparatus may comprise a memory 1002 for storing data. Furthermore the memory may store software 1004 executable by the control circuitry 1000. The memory may be integrated in the control circuitry.

The software 1004 may comprise a computer program comprising program code means adapted to cause the control circuitry 1000 of the apparatus to control communication on a shared channel, the communication utilizing a first format based on sub frame length and/or a second format based on Orthogonal Frequency-Division Multiple Access symbol length.

The apparatus may further comprise interface circuitry 1006 operationally connected to the control circuitry 1000 and configured to connect the apparatus to other devices and network elements of communication system, for example to core. The interface may provide a wired or wireless connection to the communication network. The apparatus may be in connection with core network elements, base stations and with other respective apparatuses of communication systems.

In an embodiment, the apparatus further comprises a transceiver 1008 configured to communicate with user equipment in the service area of the apparatus. The transceiver is operationally connected to the control circuitry 1000. It may be connected to an antenna arrangement (not shown). This applies especially if the apparatus is a base station.

FIG. 10B illustrates another embodiment. The figure illustrates a simplified example of an apparatus applying embodiments of the invention. In some embodiments, the apparatus may be user equipment of a communications system.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 1020 configured to control at least part of the operation of the apparatus.

The apparatus may comprise a memory 1022 for storing data. Furthermore the memory may store software 1024 executable by the control circuitry 1020. The memory may be integrated in the control circuitry. The software may comprise a computer program comprising program code means adapted to cause the control circuitry 1020 to control communication on a shared channel, the communication utilizing a first format based on sub frame length and/or a second format based on Orthogonal Frequency-Division Multiple Access symbol length.

The apparatus further comprises a transceiver 1028 configured to communicate with base stations. The transceiver is operationally connected to the control circuitry 1020. It may be connected to an antenna arrangement (not shown).

The apparatus may further comprise user interface 1030 operationally connected to the control circuitry 1020. The user interface may comprise a display, a keyboard or keypad, a microphone and a speaker, for example.

The steps and related functions described above and in the attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C. Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
control communication on a shared channel, the communication utilizing at least one of the following: a first format based on sub frame length and/or a second format based on Orthogonal Frequency-Division Multiple Access symbol length.

2. The apparatus of claim 1, wherein the resources allocated for the first format communication and the second format communication are orthogonal with each other.

3. The apparatus of claim 1, wherein the communication based on the second format has a lower latency than the communication based on the first format.

4. The apparatus of claim 1, wherein in the communication based on the second format, the length of the transmission time interval used on the connection is L times the length of an Orthogonal Frequency-Division Multiple Access symbol where L is a positive integer.

5. The apparatus of claim 1, wherein the communication based on the second format contains a dedicated control channel which is used to convey at least one of the following: scheduling grant and hybrid automatic repeat request (HARQ) ACK/NACK.

6. The apparatus of claim 1, wherein the apparatus is configured to respond to a received message on the shared channel after a processing time having a length of one or more Orthogonal Frequency-Division Multiple Access symbols.

7. The apparatus of claim 1, configured to control the communication of user equipment wherein in the communication based on the second format, the processing time from receiving a grant to transmit on the shared channel to the transmission is M1 times the length of an Orthogonal Frequency-Division Multiple Access symbol where M1 is a positive integer.

8. The apparatus of claim 1, configured to control the communication of user equipment wherein in the communication based on the second format, the processing time from receiving a control message on a control channel to an acknowledgement transmission on the shared channel is M2 times the length of an Orthogonal Frequency-Division Multiple Access symbol where M2 is a positive integer.

9. The apparatus of claim 1, configured to control the communication of an eNodeB wherein in the communication based on the second format, the processing time from receiving a communication on the shared channel to an acknowledgement transmission is N times the length of an Orthogonal Frequency-Division Multiple Access symbol where N is a positive integer.

10. The apparatus of claim 1, wherein in the communication based on the second format, the length of the transmission time interval used on the connection is L times the length of an Ortogonal Frequency-Division Multiple Access symbol where L is a positive integer, and wherein in the communication based on the second format, the apparatus being configured to utilise different transmission time interval on different channels.

11. The apparatus of claim 1, configured to control communication on one or more control channels to utilize at least one of the following: the first format based on sub frame length and the second format based on Orthogonal Frequency-Division Multiple Access symbol length.

12. A method comprising:
controlling communication on a shared channel, the communication utilizing at least one of the following: a first format based on sub frame length and a second format based on Orthogonal Frequency-Division Multiple Access symbol length.

13. The method of claim 12, wherein the resources allocated for the first format communication and the second format communication are orthogonal with each other.

14. The method of claim 12, wherein the communication based on the second format has a lower latency than the communication based on the first format.

15. The method of claim 12, wherein in the communication based on the second format, the length of the transmission time interval used on the connection is L times the length of an Orthogonal Frequency-Division Multiple Access symbol where L is a positive integer.

16. The method of 12, wherein the communication based on the second format contains a dedicated control channel which is used to convey at least one of the following: scheduling grant and hybrid automatic repeat request (HARQ) ACK/NACK.

17. The method of claim 12, further comprising: controlling the communication of user equipment, wherein in the communication based on the second format, the processing time from receiving a grant to transmit on the shared channel to the transmission is M1 times the length of an Orthogonal Frequency-Division Multiple Access symbol where M1 is a positive integer.

18. The method of claim 12, further comprising: controlling the communication of user equipment wherein in the communication based on the second format, the processing time from receiving a control message on a control channel to an acknowledgement transmission on the shared channel is M2 times the length of an Orthogonal Frequency-Division Multiple Access symbol where M2 is a positive integer.

19. The method of claim 12, further comprising:
controlling the communication of an eNodeB wherein in the communication based on the second format, the processing time from receiving a communication on the shared channel to an acknowledgement transmission is N times the length of an Orthogonal Frequency-Division Multiple Access symbol where N is a positive integer.

20. The method of claim 12, further comprising: utilising different transmission time interval on different channels when communication is based on the second format.

21. The method of claim 12, further comprising: controlling communication on one or more control channels to utilize at least one of the following: the first format based on sub frame length and the second format based on Orthogonal Frequency-Division Multiple Access symbol length.

22. An apparatus comprising:
at least one processor and at least one memory including a computer program code, the at least one memory and the computer program code configured to, with the at least one processor, cause the apparatus at least to:
control communication on a shared channel, the communication utilizing a format based on Orthogonal Frequency-Division Multiple Access symbol length.

23. The apparatus of claim 22, configured to utilize in communication a transmission time interval having a length of L times the length of an Orthogonal Frequency-Division Multiple Access symbol where L is a positive integer.

24. The apparatus of claim 22, configured to control the communication of user equipment wherein the processing time from receiving a grant to transmit on the shared channel to the transmission is M1 times the length of an Orthogonal Frequency-Division Multiple Access symbol where M1 is a positive integer.

25. The apparatus of claim 22, configured to control the communication of user equipment wherein the processing time from receiving a control message on a control channel to an acknowledgement transmission on the shared channel is M2 times the length of an Orthogonal Frequency-Division Multiple Access symbol where M2 is a positive integer.

26. The apparatus of claim 22, configured to control the communication of an eNodeB wherein the processing time from receiving a communication on the shared channel to an acknowledgement transmission is N times the length of an Orthogonal Frequency-Division Multiple Access symbol where N is a positive integer, and to
control communication on the shared channel, the communication utilizing a format based on Orthogonal Frequency-Division Multiple Access symbol length.

27. (canceled)

28. (canceled)

29. (canceled)

30. A computer program embodied on a distribution medium, comprising program instructions which, when loaded into an electronic apparatus, control the apparatus to execute method of claim 12.
